(19) United States
(12) Patent Application Publication
(10) Pub. No.: US 2026/0183970 A1
(43) Pub. Date: Jul. 2, 2026

(54) A PROGRAMMABLE PITCH CHANGER END EFFECTOR

(71) Applicant: JABIL INC., St. Petersburg, FL (US)

(72) Inventor: JEROEN BOSBOOM, St. Petersburg, FL (US)

(21) Appl. No.: 18/863,854

(22) PCT Filed: May 9, 2023
(86) PCT No.: PCT/US2023/021511

§ 371 Date: Nov. 7, 2024

Related U.S. Application Data
(60) Provisional application No. 63/339,865, filed on May 9, 2022.

(51) Int. Cl. B25J 15/00; B25J 9/10; B25J 9/16; B25J 15/06; B25J 19/02

(52) U.S. Cl. CPC B25J 15/0052; B25J 9/104; B25J 9/1653; B25J 9/1664; B25J 15/0616; B25J 19/02

(57) ABSTRACT

An apparatus, system and method for a programmable pitch changer end effector. The embodiments include: a plurality of modules, wherein one of the plurality includes a base which is positionally fixed in an x-axis, and wherein others of the plurality include bases which are capable of linear movement in the x-axis; a plurality of grippers each uniquely associated with each of the plurality of modules distal from a base of each of the plurality of modules, the plurality of grippers being capable of gripping an item in a manufacturing or packaging line; a z-axis actuator capable of moving at least one of the plurality of grippers along a z-axis closer to and farther from the gripped items; a theta axis actuator capable of moving at least one of the plurality of grippers about the z-axis in relation to the respective base of the one of the plurality of modules corresponded to the one of the plurality of grippers; and a linear movement actuator capable of providing the linear movement in the x-axis of at least one of the plurality of modules.

### CROSS-REFERENCE TO RELATED APPLICATION

This application claims the benefit of priority to U.S. Provisional Application No. 63/339,865, filed May 9, 2022, entitled PROGRAMMABLE PITCH CHANGER END EFFECTOR, the entirety of which is incorporated herein by reference as if set forth in its entirety.

### BACKGROUND

### Field Of The Disclosure

The present disclosure relates to robotics-based processing, and particularly, to an apparatus, system and method related to a programmable pitch changer end effector.

### Description of the Background

Robotic picking and placement of components often involves re-positioning components from one pitch/spacing/angle at the pick to a different pitch/spacing/angle at the subsequent component placement. The pick often also involves other component feed systems, such as a parallel guided conveyor or vibratory inline tracks.

Traditional pitch changes are often based on a helical drum-based cam or plate cams, which spread and contract multiple carriages or similar elements. However, such designs are limited in positioning flexibility due, in part, to hard-tooled positioning cam designs that dictate a fixed starting point and a fixed end position. These hard-tooled designs are also larger and heavier due to the many steel components needed for such a cam-based pitch changer.

These hard-tooled end effectors, in addition to the foregoing drawbacks, must be replaced for each new pitch/spacing/angle that is needed for a pick. Moreover, only very limited variation as between the pick and the place is tolerated by a hard-tooled end effector.

Therefore, a lighter and more agile programmable pitch/spacing/angle changer is needed that favors changeover capability, flexibility, and variability between the pick and the place.

### SUMMARY

The embodiments provide an apparatus, system and method for a programmable pitch changer end effector. The embodiments include: a plurality of modules, wherein one of the plurality includes a base which is positionally fixed in an x-axis, and wherein others of the plurality include bases which are capable of linear movement in the x-axis; a plurality of grippers each uniquely associated with each of the plurality of modules distal from a base of each of the plurality of modules, the plurality of grippers being capable of gripping an item in a manufacturing or packaging line; a z-axis actuator capable of moving at least one of the plurality of grippers along a z-axis closer to and farther from the gripped items; a theta axis actuator capable of moving at least one of the plurality of grippers about the Z-axis in relation to the respective base of the one of the plurality of modules corresponded to the one of the plurality of grippers; and a linear movement actuator capable of providing the linear movement in the x-axis of at least one of the plurality of modules.

Therefore, the embodiments provide a lighter and more agile programmable pitch/spacing/angle changer that favors changeover capability, flexibility, and variability between the pick and the place.

### BRIEF DESCRIPTION OF THE DRAWINGS

The exemplary apparatuses, systems, and methods shall be described hereinafter with reference to the attached drawings, which are given by way of non-limiting example only, and in which:

FIG. 1 illustrates aspects of a programmable pitch changer end effector;

FIGS. 2A and 2B illustrate aspects of a programmable pitch changer end effector;

FIG. 3 illustrates aspects of a programmable pitch changer end effector;

FIG. 4 illustrates aspects of a programmable pitch changer end effector;

FIG. 5 illustrates aspects of a programmable pitch changer end effector;

FIG. 6 illustrates aspects of a programmable pitch changer end effector;

FIGS. 7A and 7B illustrate aspects of a programmable pitch changer end effector;

FIGS. 8A and 8B illustrate aspects of a programmable pitch changer end effector;

FIG. 9 illustrates aspects of a programmable pitch changer end effector;

FIG. 10 illustrates aspects of a programmable pitch changer end effector; and

FIG. 11 illustrates aspects of a programmable pitch changer end effector.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a,” “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “upon,” “connected to” or “coupled to” another element or layer, it may be directly on, upon, connected or coupled to the other element or layer, or intervening elements or layers may be present, unless clearly indicated otherwise. In contrast, when an element or layer is referred to as being “directly on,” “directly upon,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

The present disclosure is directed to a programmable pitch changer, such as may take the form of an end effector. The programmable pitch changer addresses the need for a flexible and programmable pitch changer with a small, light form factor, on-the-fly positioning changeover, and high levels of flexibility as between the pick and the place. The disclosed embodiments incorporate multiple encoded servo-driven modules to position components.

By way of non-limiting example, embodiments may include four moving modules, and one fixed module, on an end effector head. The fixed module position may be robot driven, i.e., related to the position of the robot to which the end effector is associated, and the four moving modules may be servo-positioned with respect to the fixed module. Of course, the skilled artisan will appreciate, in light of the instant disclosure, that other numbers of fixed or moving modules may be provided within the scope of the embodiments.

The module position “recipe”, i.e., the combinations and variations in positions of the moving modules, may be individually programmable for position and speed. Product changeover may thus be handled with a simple program recipe change within the operational range of the end effector modules.

In additional embodiments, parts may be grouped, such as in pairs, and placed in separate or combined pockets of a placement tray (such as may move along a conveyer) without the need to conform to a simple repetitious spacing. Parts may also be combined, assembled, or joined electrically while held on or by the end effector, such as in pairs or by row, for example. That is, the flexibility of individually programmable modules enables on-the-fly secondary operations that a fixed pitch changer cannot typically accomplish.

The moving and stationary modules may incorporate a z-axis adjustment that allows for selective extension and retraction of individual ones of the modules towards and away from a pick or place tray. This enables a pick and place without running into the pick or place location, and enables selective ignorance of defective, rejected or mis-positioned parts. The disclosed end effector may also selectively ignore parts, such as by not extending for a part pick, when those parts fail a pre-inspection, by way of example. Similarly, the modules may include a part presence sensor to detect the presence or absence of a part, which may prevent part and tray damage. All of the foregoing additionally reduces scrap.

The modules may also incorporate a theta-axis adjustment, such as to rotate the parts around a vertical axis. This addresses part picks and placements that require width and rotation adjustment to acquire or release an aligned part.

The end effector moving modules may be arranged on linear bearing rails for low friction, durability and positioning repeatability. The main servo-driven belts for the moving modules may position the modules transversely, the module Z-axis may raise and lower the work tooling, and the theta axis may rotate the tooling about the Z-axis. Modules may also be arranged in multiple rows to do parallel work.

Each module may be driven by a dedicated drive belt for low inertia, light weight positioning and repeatability, by way of non-limiting example. Alternative embodiments may use drive chains, such as a miniature stainless steel chain, such as in hot or caustic environments in which rubber belts may fail.

Each servo-driven module may have a dedicated electrical and pneumatic harness service, such as using a miniature “guide chain”. Additional embodiments may use an electrical ribbon cable or a combined electrical and pneumatic ribbon cable. Grip open/close, vacuum on/off, theta on/off, part presence on/off, grip position sensing and/or encoder position signals are typical signals which may be routed in these ways.

Moreover, a compact onboard servo driver board may control the individual module positions and the I/O for the pneumatics. All of the foregoing, in the aggregate, may minimize the harness size to the end effector. Yet further, an integrated pneumatic valve block may be mounted integrally to the end effector for rapid response and further minimizing the harness size to the end effector.

More specifically, the embodiments may include a multi-module, such as a 5 module, end effector with a programmable, variable pitch. More have more modules or fewer modules, given space limitations and the run-length needed for each module. Further, the number of modules may be dependent on the run-length between pick or place positions, and some modules may be active/inactive dependent upon such positioning.

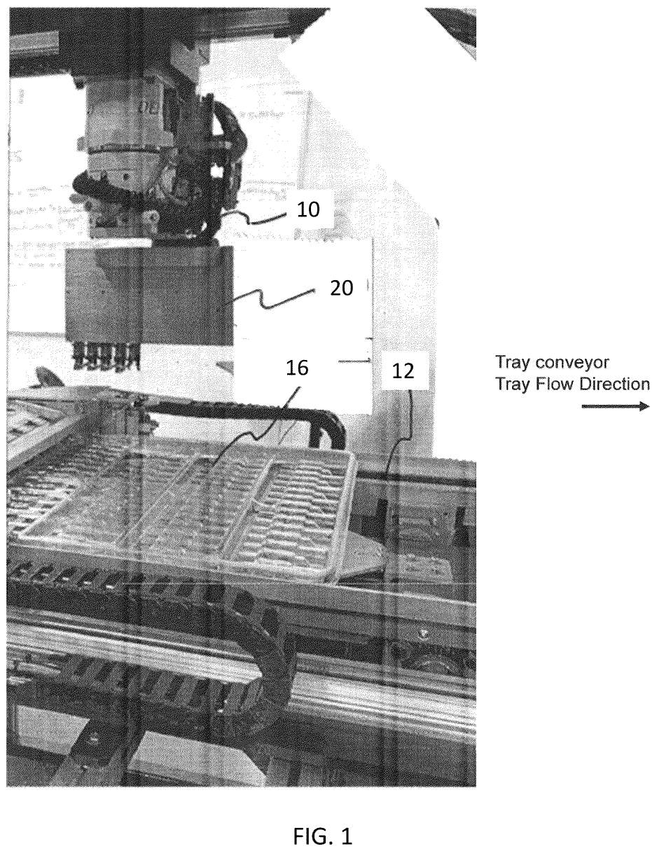

FIG. 1 illustrates a moving robotic head 10, which may typically be a ceiling mount that “reaches down” to a conveyer(s) 12 running along at least a x-axis, and in many cases along the x- and y-axes. Accordingly, the pick tray 16 may run along one of the x- or y-axis, and the place tray may run along the other axis. Attached to the robotic head 10 is a programmable pitch changer end effector 20.

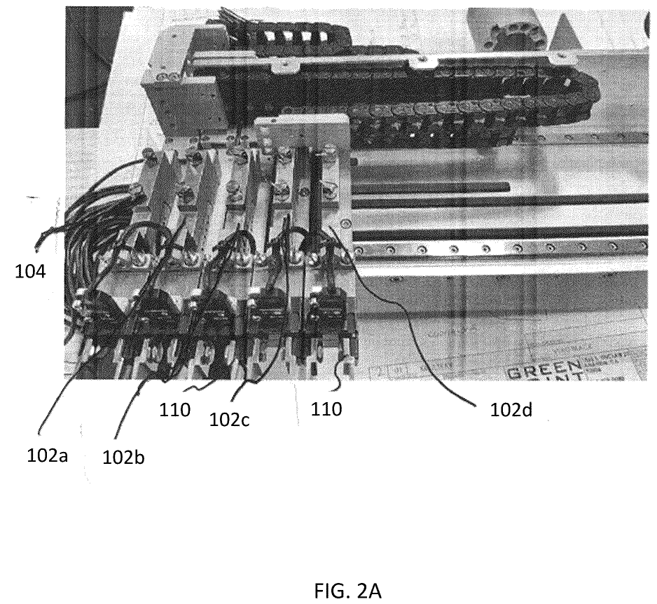

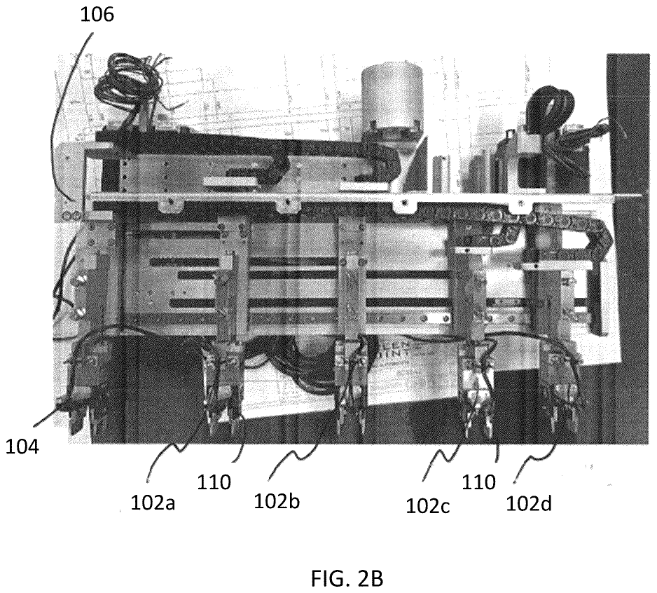

FIGS. 2A and 2B illustrate that the moving modules 102a, b, c, d may move on a common base rail or rails. A non-moving module 104 at the end rail 106 may provide the zero pitch, i.e., it may be maintained in a certain position such that the programmable y-axis movements of the other modules 102a, b, c, d along the common rail(s) may be taken from that maintained zero point. Of course, in additional embodiments, non-moving module 104 may be centered, rather than abutting an end rail, with an odd or even number of moving modules 102a, b, c . . . fanning out and converging to the center module.

Each moving module 102a, b, c, d may have a dedicated drive belt and drive motor, such as an encoded servo motor to allow for the programmability, and the belt (and thus the run) length for each module may vary based on its minimum and maximum positions, as detailed further below. These belts, motion stops, and belt drives (from the respective motors) may be staggered along the end effector base plate, as is also detailed further below.

The skilled artisan will appreciate, in light of this discussion, that the individual modules may be driven by alternative means, such as pneumatically. In such a case, pick and place positions may be more limited as to pitch therebetween, as each module may be limited to a minimum and maximum run (thereby limiting to two the available pitches for the pick and the place trays); or, intermediary motion stops may be provided in such an alternative embodiment, whereby additional pitch positions are available to each module in the y-axis.

Dependent upon the size, shape and type of picked and placed item, it is typical that each module would terminate in a gripper 110. The gripper 110 may be a fork type, mechanically, electrically or pneumatically actuatable pincer or clasp type, hook type, or the like, and the type of gripper 110 employed may depend on the picked and placed item.

Each module may additionally include a dedicated actuator, a z-axis drive (which may be dedicated for each module or which may function across several or all modules) to raise and lower the module, and/or a part sensor to sense the presence or shape or position or grabbing of the picked and placed part. Each module may additionally have a theta-axis drive (which may be dedicated for each module or which may function across several or all modules).

Thereby, given the capabilities provided above, the instant modules can individually and selectively pick from and place to trays. The variable pitch allows for this to be done without disturbing adjacent parts for trays of variable size related to the items, including in instances where the pick tray and the place tray differ in pitch and/or orientation.

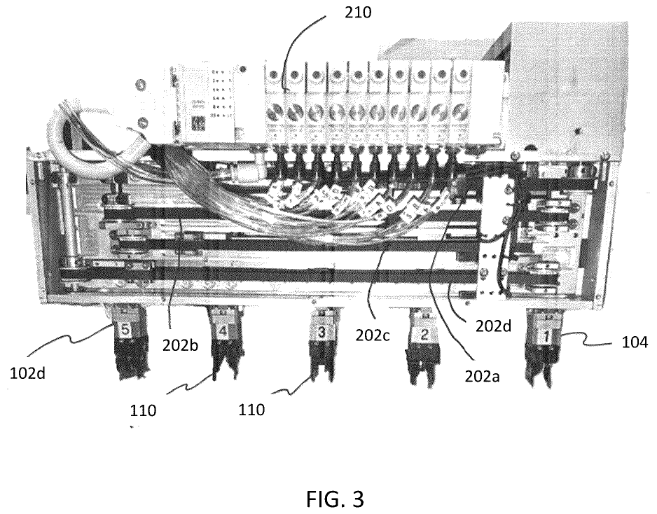

In the illustration of FIG. 3, there are 5 modules, 4 of which modules 102a, b, c, d move in the Y- and Z axes. The fifth module 104 moves only in the z-axis. Each of the 4 moving modules has its own drive belt 202a, b, c, d and dedicated stepper motor in the embodiment shown. The motors may preferably step the drive belt 202a, b, c, d in unison with each other, expanding and retracting together so as to avoid conflicting movements.

Also shown is an integrated pneumatic block 210. The pneumatics may, in some embodiments, independently and programmably, or in unison, actuate the grippers 110 at the ends of each module 102a, b, c, d, 104. Similarly, these grippers 110 may be electrically, electomechanically, pneumatically, or otherwise actuated.

As such, the embodiments provide programmability without the need to swap out end effectors. This programmability may be provided for different tray widths, orientations, and pitches, as well as for different robotics and conveyer configurations, all with a single end effector.

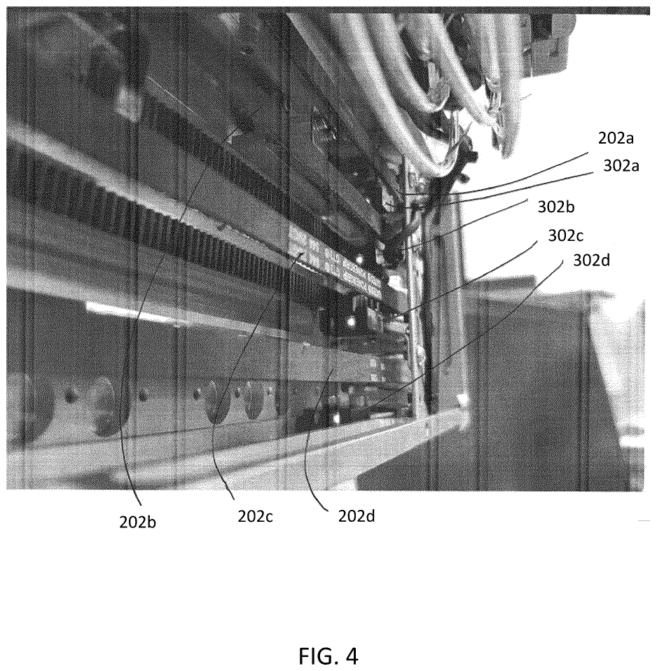

As illustrated in FIG. 4, each module's drive belt 202a, b, c, d (and motor) may have corresponded thereto a homing, distance, or similar sensor 302a, b, c, d. This sensor allows for the sensing of the module base as it is moved by the drive belt 202a, b, c, d.

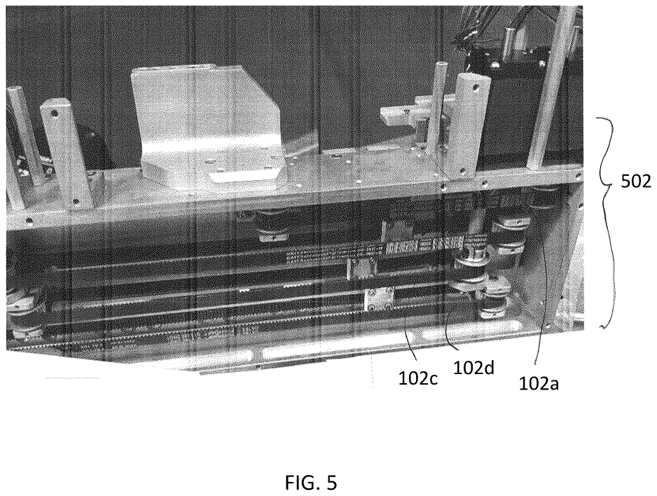

FIG. 5 again illustrates the disclosed end effector 502. The embodiments may preferably have a small and lightweight form factor. By way of non-limiting example, in the illustrated embodiment the length of the end effector 502 may be in the range of 250-500 mm, such as about 350 mm; the width may be in the range of 100-300 mm, such as about 215 mm; the height may be in the range of about 100-300 mm, such as 225 mm; and the total weight of the end effector 502 may be in the range of 2-10 kg, such as about 5 kg. The skilled artisan will appreciate that these ranges are given by way of example only.

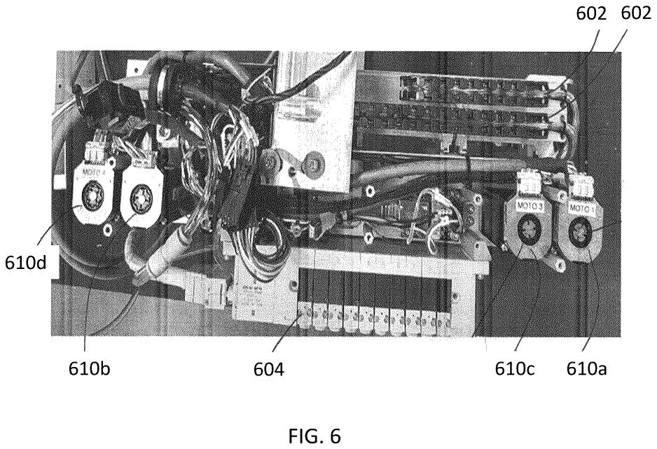

As shown in FIG. 6, each module may have its own dedicated cable management system 602, and may additionally have its own pneumatics 604 (which may be common sourced on the end effector), such as for vacuum cup grippers 110 (not shown in FIG. 6). Also illustrated are the servo motors 610a, b, c, d (and related encoders) for each of the 4 belt drives for the 4 moving modules 102a, b, c, d.

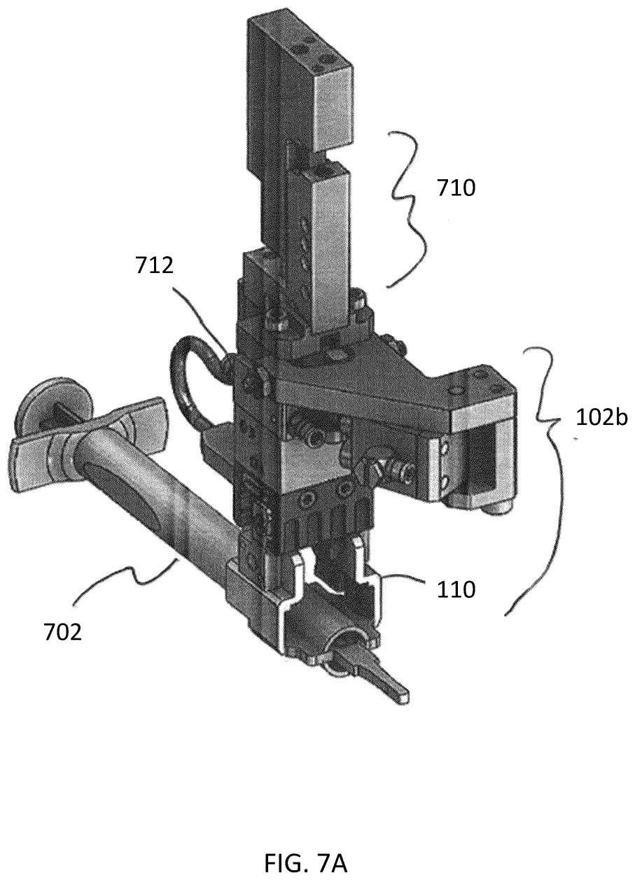

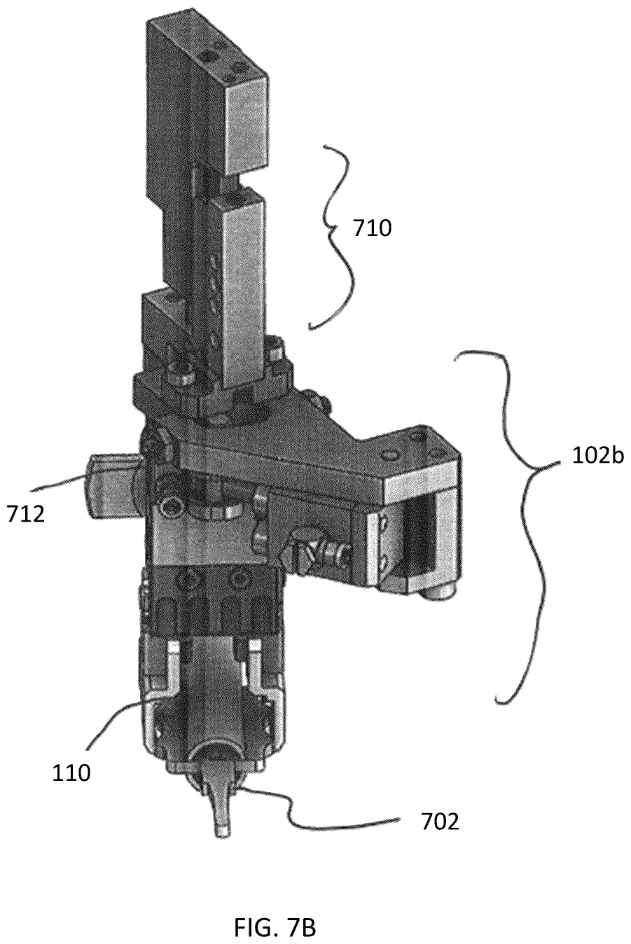

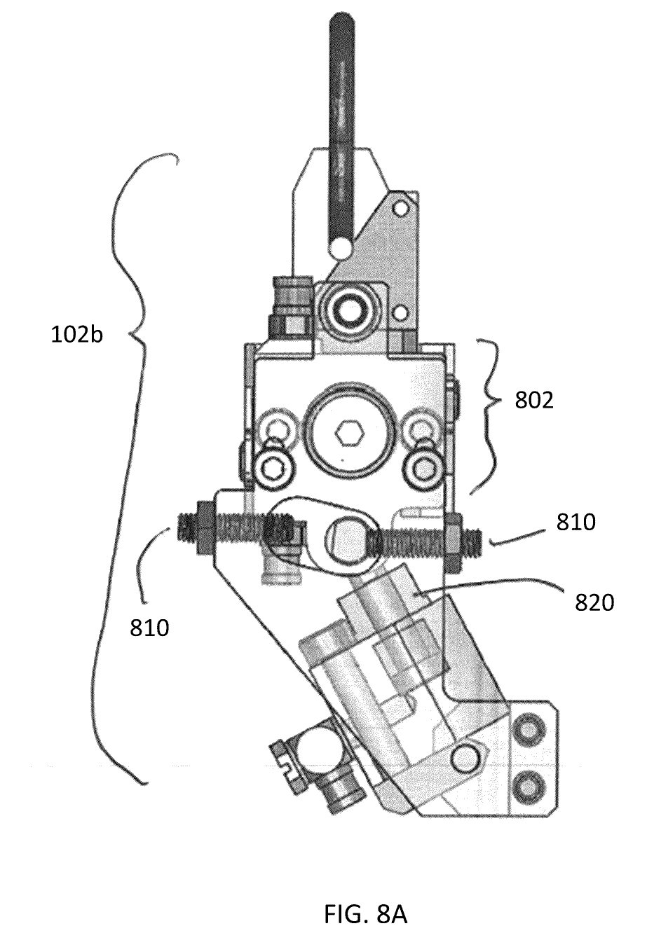

FIGS. 7A and 7B illustrate the handling of a syringe 702. More specifically, illustrated is a module 102b handling a syringe 702 in its gripper 110. Further shown is the actuated extension 710 of the module 102b downward along the z-axis, and the actuated rotation 712 of the module in its theta axis. These positional changes may be effected pneumatically, for example. For example, the module may include a guided cylinder with a double acting air cylinder, such as having a 10 mm stroke.

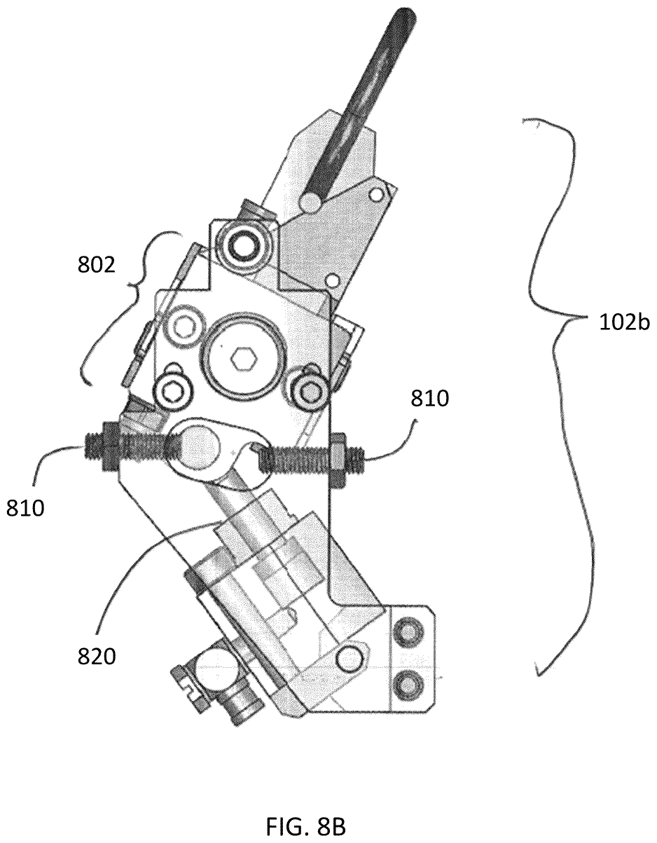

FIGS. 8A and B show a top view of the module 102b shown in FIGS. 7A and B, above. Evident in this top view is the un-rotated (in the theta axis) module head 802, and the head 802 rotated in the theta axis. This rotation may be positionally encoded to be capable at numerous stop points between, for example, travel stops 810 on the module head 802 as shown. By way of non-limiting example, the rotation may be effectuated be actuation to any of the numerous positions of a single acting spring extend cylinder 820, as illustrated.

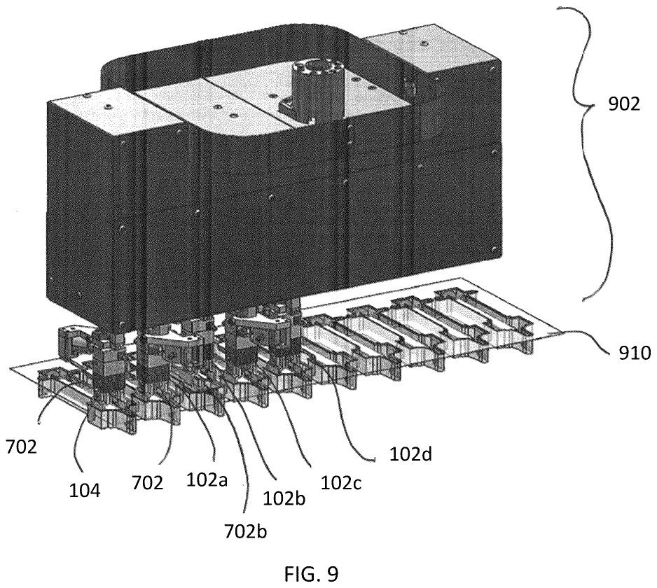

FIG. 9 illustrates a 5 module end effector 902 picking syringes 702 from a pick tray 910. The pitch changer end effector 902 extends each of modules 102a, c, d, 104 downward in the z-axis to the pick tray 910 to acquire each syringe 702. Of note, in the illustration, a misplaced/malformed part was detected up stream, and was flagged. Correspondingly, the pick module 102b aligned above that part 702b in the pick tray has automatically stayed retracted to avoid picking up the faulty/misplaced syringe.

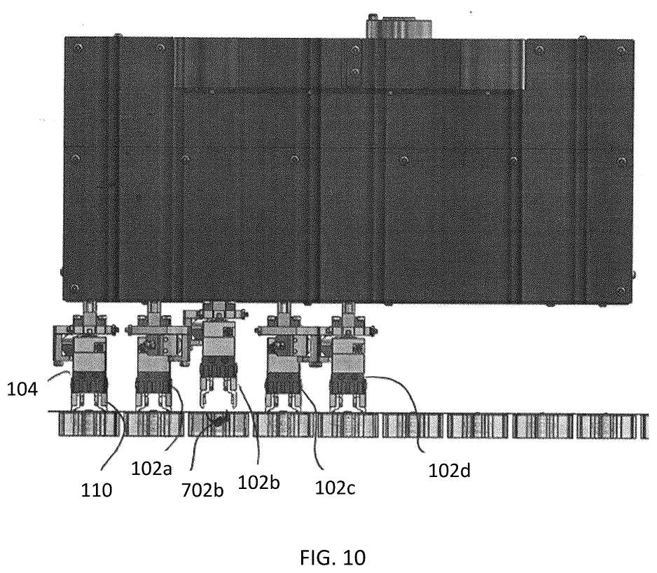

The detection of the misplaced/faulty part 702b in the prior Figure is illustrated in a cross-sectional view in FIG. 10. Of note, it is again evident that the module 102b corresponded to the faulty part 702b is not extended downward in the z-axis toward the pick tray 910, so as not to pick the faulty part 702b.

Needless to say, active sensing/feedback may be used to avoid picking faulty parts, or to avoid placing parts in already-filled slots in a placement tray. For example, pressure sensing when the modules extend to place the syringes may enable sensing of an already-loaded pocket, so that the already-loaded slot may be skipped while the remaining pockets may be loaded.

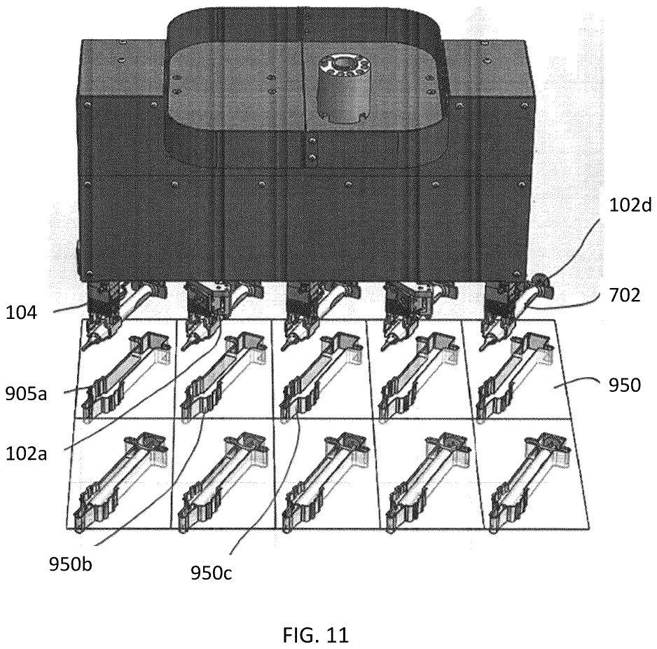

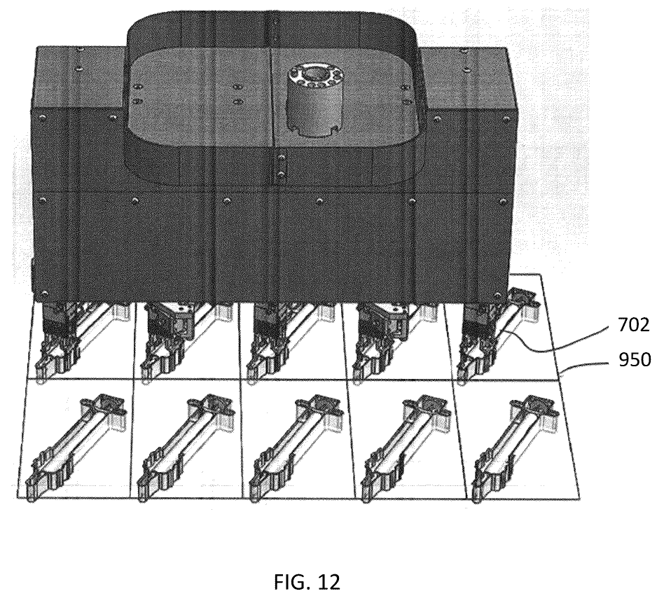

FIG. 11 illustrates the placement of the picked syringes 702 into a placement tray 950 (in this case, by way of non-limiting example, the placement tray comprises a blister pack). Of note, the placement tray 950 differs from the illustrated pick tray 910 in both the pitch between syringes 702 and the angle of the syringes 702.

That is, the pitch changer end effector may change the pitch of its modules 102a, b, c, d, 104, as shown in FIG. 11, from the pick function. Moreover, the module heads 102a, b, c, d, 104 are adjusted in the theta axis (either before, after, or during the extension of the z-axis functions for each module) to comport with the angular change in the placement tray 950a, b, c locations from those shown above for the pick tray 910.

As shown in FIG. 12, the blister (placement) tray 950 is populated with syringes 702, and may thereafter be hermetically sealed, such as with a cover of blister packaging. The pitch changer's theta-adjustment thus saves cost by providing a method to efficiently match the tray pockets of both the pick 910 and place 950 trays. This cost savings may stem, from other things, by optimizing trays for material savings and conveyer configurations by allowing for rotation and pitch changes of the tray contents.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather are to be accorded the widest scope consistent with the principles and novel features disclosed herein.

What is claimed is:

1. A programmable pitch changer end effector, comprising:
a plurality of modules, wherein one of the plurality includes a base which is positionally fixed in an x-axis, and wherein others of the plurality include bases which are capable of linear movement in the x-axis;
a plurality of grippers each uniquely associated with each of the plurality of modules distal from a base of each of the plurality of modules, the plurality of grippers being capable of gripping an item in a manufacturing or packaging line;
a z-axis actuator capable of moving at least one of the plurality of grippers along a z-axis closer to and farther from the gripped items;
a theta axis actuator capable of moving at least one of the plurality of grippers about the z-axis in relation to the respective base of the one of the plurality of modules corresponded to the one of the plurality of grippers; and
a linear movement actuator capable of providing the linear movement in the x-axis of at least one of the plurality of modules.

2. The programmable pitch changer end effector of claim 1, wherein each of the z-axis actuator is uniquely corresponded to one of the plurality of modules.

3. The programmable pitch changer end effector of claim 1, wherein each of the theta axis actuator is uniquely corresponded to one of the plurality of modules.

4. The programmable pitch changer end effector of claim 1, wherein the grippers comprise vacuum grippers.

5. The programmable pitch changer end effector of claim 1, wherein the grippers comprise one of a fork and a pincer.

6. The programmable pitch changer end effector of claim 1, wherein the grippers comprise a clasp.

7. The programmable pitch changer end effector of claim 1, wherein each of the linear movement actuator is uniquely corresponded to the bases capable of the linear movement.

8. The programmable pitch changer end effector of claim 7, wherein the linear movement actuators comprise drive belts.

9. The programmable pitch changer end effector of claim 8, wherein the drive belts are driven by motors.

10. The programmable pitch changer end effector of claim 9, wherein the motors are servo-motors.

11. The programmable pitch changer end effector of claim 10, wherein the servo-motors are encoded.

12. The programmable pitch changer end effector of claim 1, further comprising sensors that monitor the linear movement.

13. The programmable pitch changer end effector of claim 1, further comprising sensors that monitor actuation of the z-axis actuator.

14. The programmable pitch changer end effector of claim 13, wherein the actuation of the Z-axis actuator is negated based on the sensors.

15. The programmable pitch changer end effector of claim 14, wherein the actuation is negated because a faulty part is detected by the sensors.

16. The programmable pitch changer end effector of claim 1, wherein the linear movement actuators comprise drive chains.

17. The programmable pitch changer end effector of claim 1, wherein the plurality of modules comprises 5 modules.

18. The programmable pitch changer end effector of claim 1, wherein the theta axis actuator modifies a position of a corresponded one of the plurality of grippers about the z-axis as between a pick function and a place function for the gripped item.

19. The programmable pitch changer end effector of claim 1, wherein the linear movement actuator modifies a position of a corresponded one of the plurality of grippers as between a pick function and a place function for the gripped item.

20. The programmable pitch changer end effector of claim 1, wherein the theta axis actuator comprises at least two motion stops.
